(19) United States
(12) Patent Application Publication
(10) Pub. No.: US 2007/0223304 A1
(43) Pub. Date: Sep. 27, 2007

(54) Structural improvement handy mixer

(76) Inventor: Yuehting Chen, Fongyuan City (TW)

Correspondence Address: YUEHTING CHEN, P.O. Box 697, Fongyuan City, Taichung County, 420, TW

(21) Appl. No.: 11/387,743

(22) Filed: Mar. 24, 2006

(51) Int. Cl. B01F 7/16

(52) U.S. Cl. 366/197; 366/249

(57) ABSTRACT

A structural improvement handy mixer includes a base having a pair of rear rollers, a pair of front pads, a pair of vertical bars on rear end connected to a transverse bar and pivoted to a pair of longitudinal bars which have their free end connected to a pair of hollow interior rectangular posts, a U-shaped rail slidably connected to the top of the posts with an adjustment device engaged therebetween, an operational mechanism on the rear portion of the base to operate a stirring bar at front side, a mixing barrel on the front portion of the base protected by a pair of guard railings and a sensor nearby a lid to control the operation of the operational mechanism.

### BACKGROUND OF THE INVENTION

The present invention relates to mixing the concrete, glue, paint and other mixture materials and more particularly to a structural improvement handy mixer which is safe and convenient.

Nowadays, in small-sized construction or in small-amount manufacturing, people are used to use a portable electric stirring bar to mix concrete, glue, paint and/or other mixture materials in a barrel. The worker is getting exhausted after long time operation due to the grasp of the big and heavy stirring bar. Besides, this type of stirring bar lacks of safety device, causing the worker is always exposed in a hazardous condition. Therefore a safe handy mixer to replace this type of stirring bar is indispensable.

### SUMMARY OF THE PRESENT INVENTION

The present invention has a main object to provide a structural improvement handy mixer in which the stirring bar is correctly positioned in the mixing barrel without grasping by the worker's hand and the structure and the operation of the mixer are safe and convenient.

Another object of the present invention is to provide a structure improvement handy mixer when opens the lid of the mixing barrel, the whole system will be stopped until the lid is covered and the switch turns on again.

Further object of the present invention is to provide a structural improvement handy mixer in which the whole machine is carried by a movable base.

Accordingly, the handy mixer of the present invention comprises generally a movable base having an adjustable rail and guard railings, a mixing barrel including a stirring bar disposed therein and operated by a motor, a gear box and a sensor on a top which is functioned when the lid is opened, the whole machine will be stopped the operation until the lid is covered on and the switch is turned on again.

The present invention will become more fully understood by reference to the following detailed description thereof when read in conjunction with the attached drawings.

### BRIEF DESCRIPTION OF THE DRAWINGS

FIG. 1 is a perspectively to show the preferred embodiment of the present invention,

FIG. 2 is an exploded perspective view to show the details of the positioning pieces for adjusting the height a the U-shaped rail,

FIG. 3 is a sectional view taken along line 1-1 of FIG. 1,

FIG. 4 is a sectional view taken along line 1′-1′ of FIG. 1,

FIG. 5 is an exploded perspective view to show the detail of a sensor,

FIG. 6 is an exploded perspective view to show that the lid of the mixing barrel is removed,

FIG. 7 is a plane view to show the lid is opened, and

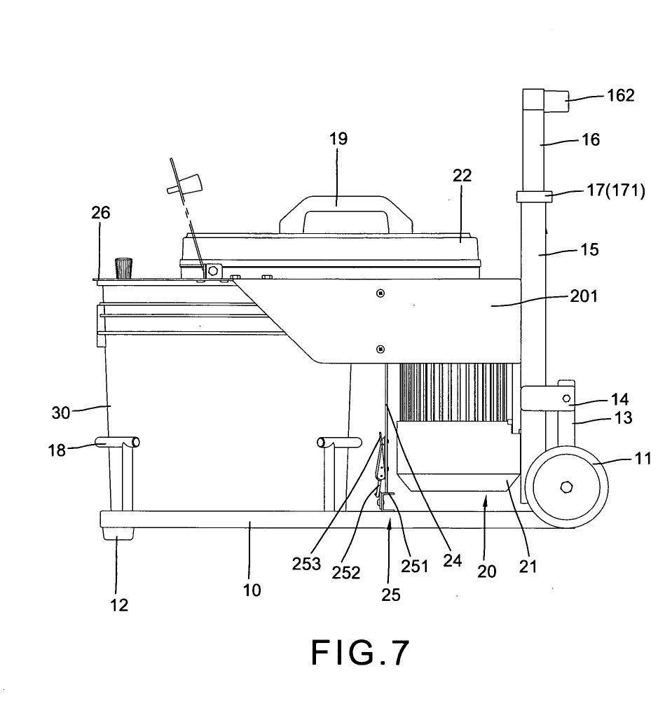

FIG. 8 is a plane view to show the operational mechanism including the stirring bar are raised up getting apart from the mixing barrel.

### DETAILED DESCRIPTION OF THE PREFERRED EMBODIMENT

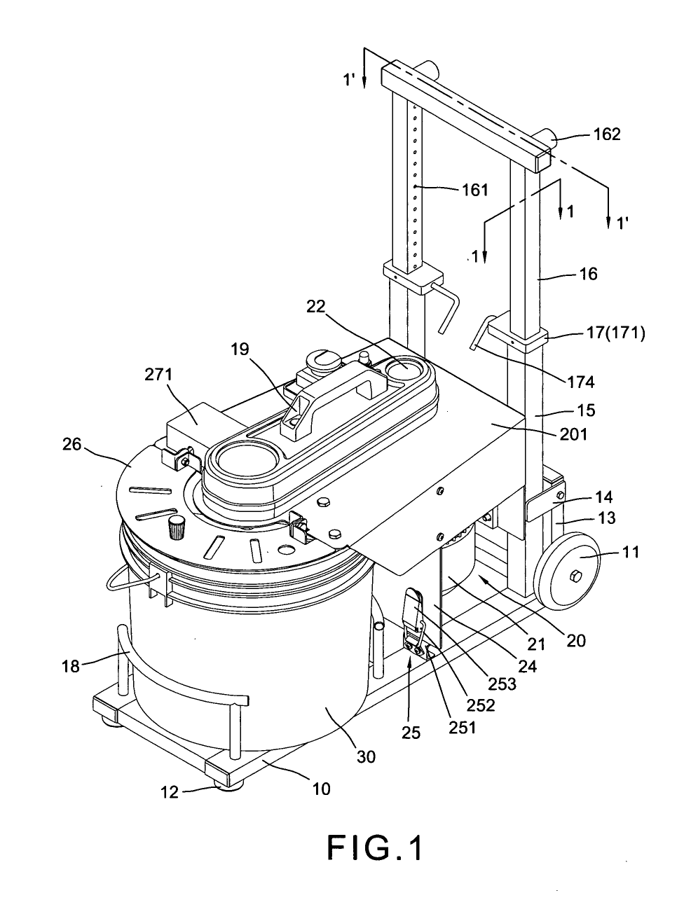

With reference to FIG. 1 of the drawings, the handy mixer of the present invention comprises generally a movable base 10, an operational mechanism 20 and a mixing barrel 30.

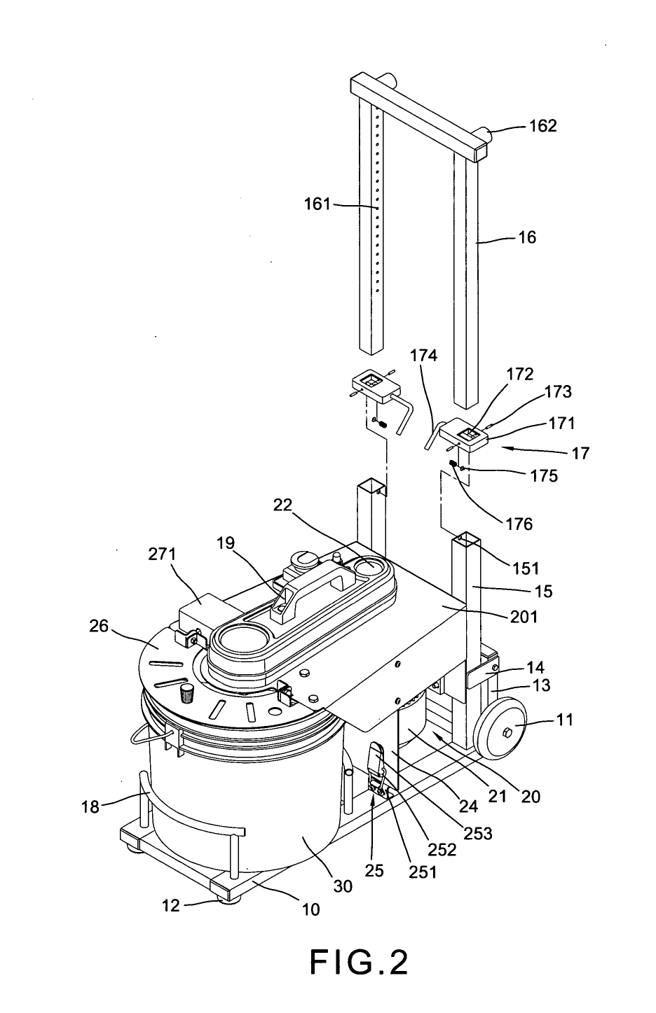

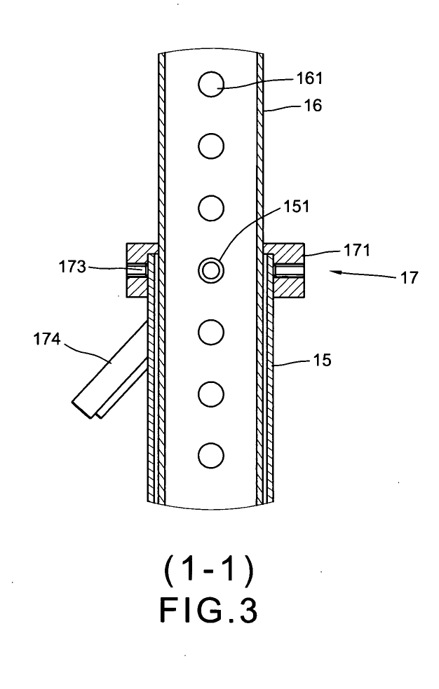

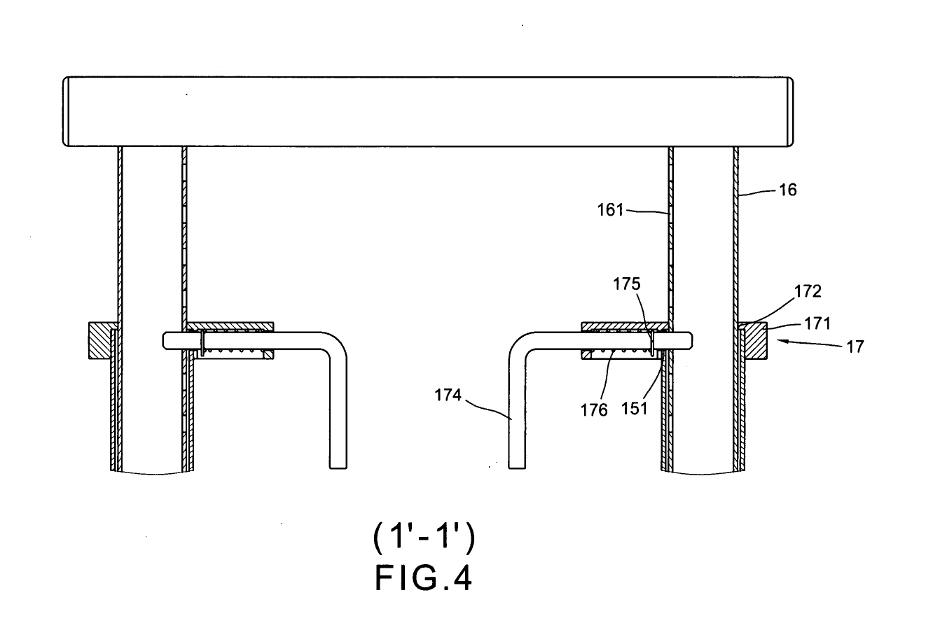

The base 10 is of a rectangular shaped composed of a number of longitudinal and transverse bars and has a pair of rollers 11 respectively and rotatably secured to the outer sides of the rear corners, a pair of pad 12 spacedly formed under front corners so that the base is movable, a pair of vertical support bars 13 rotatably connected to a pair of longitudinal bars 14 and a transverse bar for supporting a pair of hollow interior rectangular posts 15 which is integrated with a roughly U-shaped plate 201 and the longitudinal bars 14 and a pair of through holes 151 respectively formed in their opposing inner surface facing one another, an adjustment device 17 including a pair of rectangular positioning pieces 171 respectively secured to the top of the posts 15 by a pair of screws 173. Therebetween, the positioning pieces 171 each has a rectangular through hole near outer side communicated with the interior of the posts 15 and a through hole in inner side. A roughly U-shaped hollow interior rail 16 has a pair of lateral portions insertible into the posts 15 via the pair of rectangular through holes 172 of the positioning pieces 17 and each has an alignment of through holes 161 in inner side enageable with a pair of L-shaped handles 174 which are inserted into the post 15 from inner side of the positioning pieces 171 and biased by a pair of springs 176 and a pair of annular rings 175 and functioned to adjust the height of the U-shaped rail 16 (as shown in FIGS. 3 and 4). The rail 16 farther has a pair pads 162 spacedly formed on an back side of the top thereof (as shown in FIG. 2). When the L-shaped handles insert into any one of the alignment of the through holes 161 of the lateral positions, the U-shaped rail 16 is fixed up. Contrarily if disengages the L-shaped handles with the through holes 161, the U-shaped rail 16 becomes slidable within the post 15, so as to adjust the height of the rail 16. The springs 176 provide the resilience to the L-shaped handles and the pads 162 are provided to facilitate the handy mixer laying on the ground.

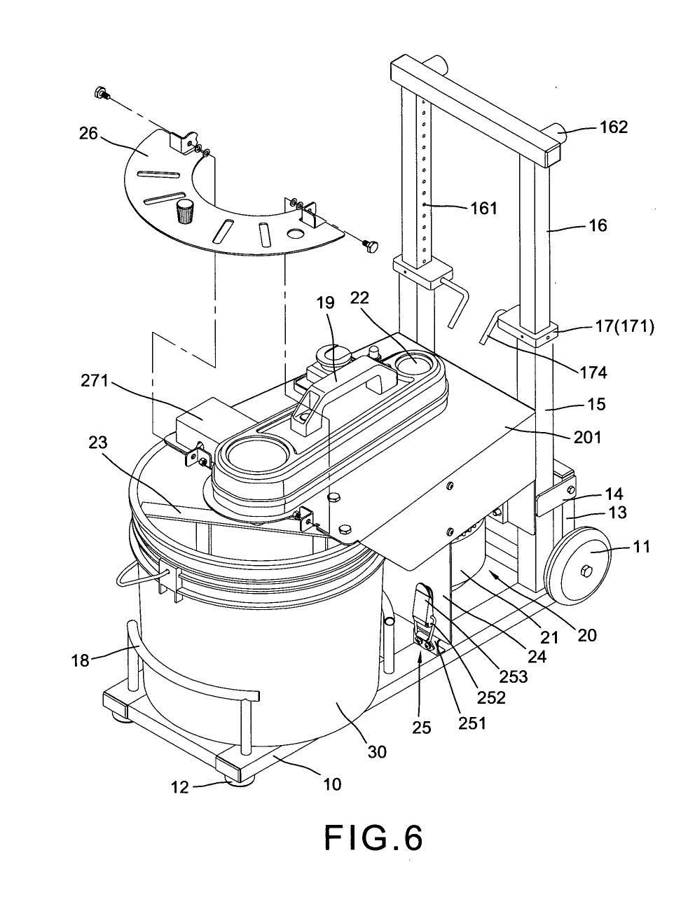

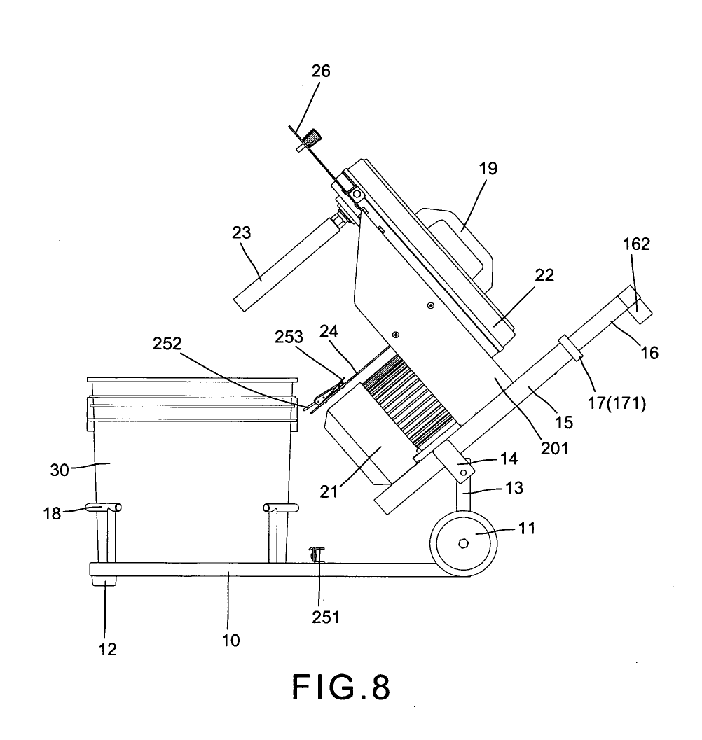

The operational mechanism 20 is positioned on the rear portion of the base 10 and integrated with the posts 15 through the roughly U-shaped plate 201 and composed of a motor 21 on the bottom and a gear box 22 on the top actuated by the motor 21. The gear box 22 has a hiding gear train which operates a stirring bar 23 inside the stirring barrel 30 (as shown in FIGS. 6 and 8) via a chain and a handle 19 positioned at a top therebetween. A vertical plate 24 disposes under the U-shaped plate 201 and has at bottom a pair of spaced quick disassembly device 25 each of which is composed of a locking plate 251 integrated on a pair of the outmost longitudinal bars, a buckle 252 rotatably secured to an eccentric press plate 253 on the vertical plate 24. The buckles 252 are normally hooked on the locking plates 251. When pull the eccentric press plate 253 outward relative to the vertical plate 24, the buckles are disengaged with locking plate 251 so as to permit the operational mechanism 20 to move clockwise together with the posts 15.

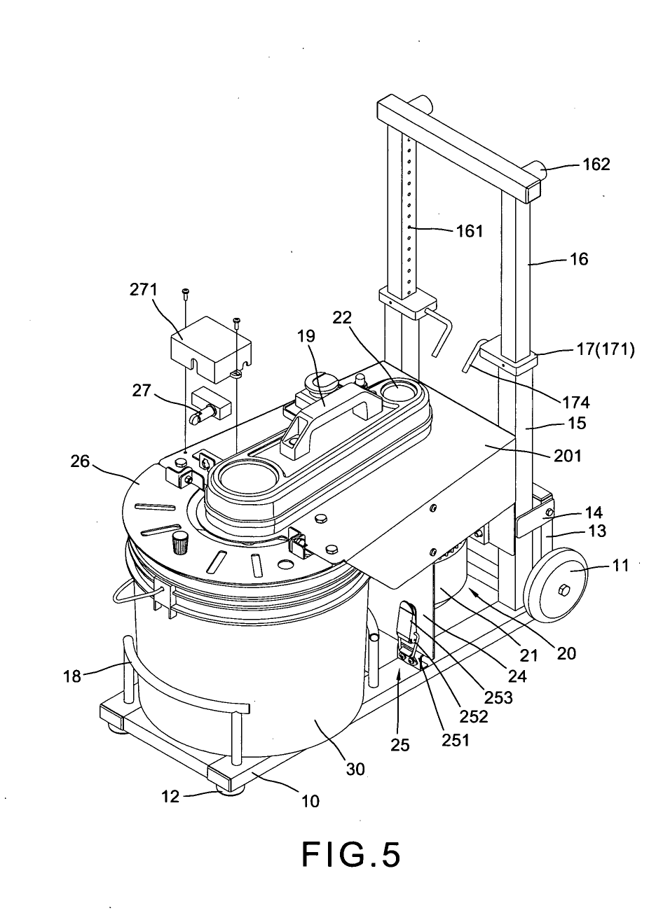

The mixing barrel 30 is positioned at the front portion of the base 10 and protected by a pair of guard railings 18 and has a semi-circular lid 26 pivoted to the front side of the U-shaped plate 201 covering half of the barrel 30 (as shown in FIGS. 5 and 6) and a sensor 27 disposes on a top of the U-shaped plate 201 closed to the lid 26 and protected by a cover 271. When the lid 26 is opened, the sensor 27 will be functioned to stop the rotation of the motor 21 and the gear train. If the user wants to start the mixing process continuously, he has to start the motor 21 again.

In operation, first release the pair of quick disassembly devices 25 and turn the U-shaped rail 16 downward to raise the operational mechanism 20 together with the lid 26 and the stirring bar 23 up (as shown in FIG. 8) permitting the user to pour the working materials into the mixing barrel 30. Then release the U-shaped rail 16 to allow the operational mechanism 20, the stirring bar 23 and the lid 26 back to their original positions and lock the quick disassembly devices 25 again so it gets ready to start the motor 21 to operate the stirring bar 23 via the gear train. When the mixing process has been done, releases the quick disassembly devices and raise the operational mechanism 20 together with the stirring bar 23 and the lid 26 up as discussed the above, then the user is permitted to remove the mixing barrel 30 together with the mixture from the base 10 to perform his gob nearby the base 10.

The handy mixer of the present invention is characterized in structural simplicity such as a fulcrum developed between the vertical and longitudinal support rods 13 and 14 facilitate the raising up of the operational mechanism 20 to give great convenience to pour the working materials into the mixing barrel 30 and the rollers on the base 10 to enable the base 10 to be movable.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. A structural improvement handy mixer comprising:
a movable base of rectangular shape composed of a number of first longitudinal and first transverse bars and having pair of rollers respectively and rotatably secured to an outer side of rear corners and a pair of first pad spacedly disposed under front corners, and a pair of vertical bars pivoted to a pair of second longitudinal bars and connected to a second transverse bar;
a pair of hollow interior rectangular posts connected respectively on outer side to a free end of said second longitudinal bars and on front side to a U-shaped plate and each having an upper opening and a first through hole in an inner side abutting the opening facing one another;
a hollow interior U-shaped rail having a transverse portion, a pair of lateral portions respectively inserted into the openings of said rectangular posts adjustably secured by an adjustment device and each having an alignment of through holes in inner side facing one another, and a pair of second pad spacedly disposed on backside of the transverse portion;
an operational mechanism positioned at rear portion of said base and composed of a motor actuating a gear train in a gear box on said U-shaped plate for operating a stirring bar at front portion via a chain with a handle positioned therebetween, a semi-circular lid pivoted to a front end of said U-shaped plate, a sensor on a front top near said lid and protected by a cover and a vertical plate on an under side of said U-shaped plate connected to said base by a pair of quick disassembly devices;
a mixing barrel on front position of said base protected by a pair of guard railings and covered up by said lid and said U-shaped plate;
whereby release the quick disassembly devices and turn the U-shaped rail downward, said operational mechanism is raised up from said mixing barrel.

2. The handy mixer as recited in claim 1, wherein said adjustment device having a pair of positioning pieces secured to the upper opening of said posts respectively and each having a rectangular hole engaged with the upper opening, a second through hole in an inner side communicating to inside of said posts via said first through holes and a L-shaped handle inserted into said first and second through holes and checked into one of said alignment of through holes of said U-shaped rail with a spring and an annular ring biased thereinbetween.

3. The handy mixer as recited in claim 1, wherein said quick disassembly device each has a locking plate integrated with an outmost first longitudinal bar of said base and a buckle pivoted to an eccentric press plate on lower end of said vertical plate and locked up by said locking plate.
